(19) United States
(12) Patent Application Publication
(10) Pub. No.: US 2025/0201815 A1
(43) Pub. Date: Jun. 19, 2025

(54) ELECTRODE AND BATTERY

(71) Applicant: TOYOTA JIDOSHA KABUSHIKI KAISHA, Toyota-shi (JP)

(72) Inventor: Shinichiro Ito, Kosai-shi (JP)

(73) Assignee: TOYOTA JIDOSHA KABUSHIKI KAISHA, Toyota-shi (JP)

(21) Appl. No.: 18/817,501

(22) Filed: Aug. 28, 2024

(30) Foreign Application Priority Data
Dec. 13, 2023 (JP) 2023-210386

(51) Int. Cl. H01M 4/36; H01M 4/02

(52) U.S. Cl. CPC H01M 4/366; H01M 2004/021; H01M 2004/028

(57) ABSTRACT

The electrode according to the present disclosure includes a current collector and an active material layer provided on the current collector, wherein the active material layer has a basis weight larger than 20 mg/cm² and a coating area of 600 cm² or more, and a high-density portion having a high density of the active material is provided at the center, and an inclined portion having a low density of the active material from the center toward the edge is provided at the peripheral edge.

### CROSS-REFERENCE TO RELATED APPLICATION

This application claims priority to Japanese Patent Application No. 2023-210386 filed on Dec. 13, 2023, incorporated herein by reference in its entirety.

### BACKGROUND

### 1. Technical Field

The present disclosure relates to an electrode and a battery.

### 2. Description of Related Art

In a battery having an electrode provided with an active material layer on a surface of a current collector, there is demand for increasing electrolyte solution impregnation properties of the active material layer.

For example, Japanese Unexamined Patent Application Publication No. 2019-169391 (JP 2019-169391 A) discloses technology for reducing density of an active material at a peripheral edge of an active material layer, in order to enhance electrolyte solution impregnation properties of the active material layer.

### SUMMARY

The inventors have found the following problems regarding electrodes and batteries.

When thickness and coating area of the active material layer are great, it is more difficult to sufficiently perform impregnation by electrolyte solution to the middle of the active material layer, as compared to when the thickness and the coating area of the active material layer are small. Accordingly, there is room for improvement in the technology for enhancing electrolyte solution impregnation properties of the active material layer.

The present disclosure has been made in view of such problems, and an object thereof is to provide an electrode and a battery in which electrolyte solution impregnation properties of an active material layer are further improved.

One aspect for achieving the above object is
an electrode including
a current collector, and
an active material layer provided on the current collector, in which
a basis weight of the active material layer is greater than 20 mg/cm², and also a coating area is no less than 600 cm², and
a high-density portion, of which density of active material is high, is provided at a middle of the active material layer, and an inclined portion, in which the density of the active material decrease from the middle toward an edge, is provided at a peripheral edge of the active material layer.

One aspect for achieving the above object is a battery including the above-described electrode.

According to the present disclosure, an electrode and a battery can be provided in which electrolyte solution impregnation properties of an active material layer are further improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of an electrode according to a first embodiment;

FIG. 2 is a schematic diagram of an electrode according to Embodiment 2;

FIG. 3A is a schematic view showing a configuration of a coating device used in preparing an anode sample;

FIG. 3B is a schematic representation of another end form of a squeegee;

FIG. 4A is a schematic diagram showing an anode of Examples 1 to 2 and Comparative Examples 1 to 2;

FIG. 4B is a graph showing a distribution of the weight during slurry coating for a sample of Examples 1 to 2 and Comparative Examples 1 to 2;

FIG. 4C is a diagram showing a distribution of the anode density after pressing the sample of Examples 1 to 2 and Comparative Examples 1 to 2;

FIG. 5 is a graph showing the anode liquid retention ratio of the samples; and

FIG. 6 is a graph showing Li deposition area ratio of the respective samples.

### DETAILED DESCRIPTION OF EMBODIMENTS

Hereinafter, embodiments of the present disclosure will be described in detail with reference to the drawings. In the drawings, the same or corresponding elements are denoted by the same reference numerals, and redundant descriptions are omitted as necessary for clarity of description. In addition, for ease of understanding, the scale of each part in the drawings may be different from the actual scale. In the parallel, orthogonal, orthogonal, horizontal, vertical, up-down, left-right, and the like directions, deviations to the extent that the effects of the embodiments are not impaired are allowed. Parallel, orthogonal, orthogonal, horizontal, and vertical may include substantially parallel, substantially orthogonal, substantially orthogonal, substantially horizontal, and substantially vertical. In addition, in the present specification, the term “substantially” refers to a state in which a person is considered to have the same shape and the same size when viewed.

### First Embodiment

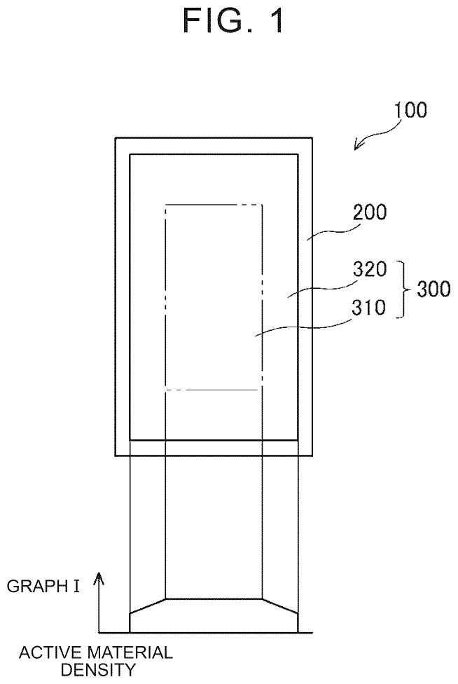

First, the configuration of the electrode 100 according to the first embodiment will be described with reference to FIG. 1. The electrode 100 is an electrode used for a battery. Specifically, the electrode 100 is an electrode of a lithium-ion secondary battery. The configuration of the battery including the electrode 100 is not particularly limited. The battery having the electrode 100 may be configured as, for example, a laminated battery, or may be configured as a square battery. Hereinafter, a case in which a laminated battery is configured as a battery having the electrode 100 will be described.

The laminated battery having the electrode 100 includes an electrode body, an electrolyte, an external terminal, and a laminated exterior body. The electrode body and the electrolyte function as a power generation element of the laminated battery. The electrode body and the electrolyte are sealed inside the laminate exterior body.

The configuration of the electrode body may be a known configuration, and is not particularly limited. The electrode body is a laminated electrode body, and includes one or more sheet-shaped positive electrode bodies and one or more anode bodies, typically a plurality of sheet-shaped positive electrode bodies. The positive electrode body and the anode body are alternately stacked in a state of being insulated from each other.

The positive electrode body typically includes a positive electrode current collector and a positive electrode active material layer formed on the surface of the positive electrode current collector. For example, aluminum is used as the positive electrode current collector. The positive electrode active material layer includes a positive electrode active material. The positive electrode active material is, for example, a lithium transition metal composite oxide such as a lithium nickel cobalt manganese composite oxide.

The anode body typically includes an anode current collector and an anode active material layer formed on the surface of the anode current collector. For example, copper is used as the anode current collector. The anode active material layer includes an anode active material. The anode active material is, for example, a carbon material such as graphite.

A separator may be disposed between the positive electrode body and the anode body. The separator insulates the positive electrode active material layer and the anode active material layer. As the separator, for example, a resin-sheet such as polyethylene (PE) or polypropylene (PP) is used.

The configuration of the electrolyte may be a known configuration, and is not particularly limited. The electrolyte may be in a liquid state, a polymer state, that is, a gel state, or a solid state. As an example, the electrolyte may include a non-aqueous solvent and a support salt, such as a lithium salt, that produces a charge carrier.

The electrode assembly is provided with a current collector tab. The current collector tab is a positive electrode current collector tab and an anode current collector tab. Specifically, the positive electrode current collector tab extends outward from the positive electrode current collector included in the positive electrode body. The anode current collector tab extends outward from an anode current collector included in the anode body. The current collector tab is exposed without including an active material layer. For example, the positive electrode current collector tab and the anode current collector tab may extend from both sides of the short side.

The external terminal is formed in a plate shape. The external terminal is electrically connected to the current collector tab by being joined to the current collector tab. Specifically, the positive electrode external terminal further extends outward from the vicinity of the distal end portion of the positive electrode current collector tab, and is exposed outward from the laminate exterior body. The positive electrode external terminal is, for example, a thin aluminum plate. The anode external terminal further extends outward from the vicinity of the distal end portion of the anode current collector tab, and is exposed outward from the laminate exterior body. The anode external terminal is, for example, a thin copper plate.

The positive electrode external terminal and the positive electrode current collector tab are bonded to each other at the bonding portion. The anode external terminal and the anode current collector tab are bonded to each other at the bonding portion. The joining method of the joints may be resistance welding, for example. The joining method of the joining portion is not particularly limited, and may be laser welding, ultrasonic joining, or the like.

FIG. 1 is a front view of an electrode 100 according to a first embodiment. The electrode 100 is a positive electrode body or an anode body constituting the electrode body. As illustrated in FIG. 1, the electrode 100 includes a current collector 200 and an active material layer 300. When the electrode 100 is a positive electrode, the current collector 200 is a positive electrode current collector, and the active material layer 300 is a positive electrode active material layer. When the electrode 100 is an anode, the current collector 200 is an anode current collector, and the active material layer 300 is an anode active material layer. The current collector 200 is a rectangular metal foil. The active material layer 300 is formed by applying a slurry containing an active material and a binder to the current collector 200 and then pressing the slurry. As shown in FIG. 1, the active material layer 300 is formed in a rectangular shape on the current collector 200. The active material layers 300 have a basis weight larger than 20 mg/cm² and a coating area of 600 cm² or more.

A high-density portion 310 is provided in the center of the active material layer 300. The high-density portion 310 is a region where the density of the active material is larger than that of the other regions. An inclined portion 320 is provided at a portion of the active material layer 300 other than the peripheral edge, that is, the high-density portion 310. The inclined portion 320 is a portion where the density of the active material gradually decreases from the center toward the edge.

Graph I is a graph schematically showing the density of the active material in the active material layer 300. As shown in the graph I, in the active material layer 300, the density of the active material is high in the central portion, i.e., the high-density portion 310, and the density of the active material gradually decreases from the center toward the edge in the peripheral portion, i.e., the inclined portion 320.

Since the inclined portion 320 is provided in the active material layer 300, the electrode 100 can sufficiently impregnate the entire active material layer 300 with the electrolyte even when the basis weight and the coating area of the active material layer 300 are large. Therefore, in the battery including the electrode 100, a decrease in charge and discharge efficiency is suppressed, and generation of gas is suppressed. Therefore, in the battery having the electrode 100, an increase in resistivity caused by spreading between the electrodes is suppressed, and a decrease in durability performance caused by Li deposition is suppressed.

### Second Embodiment

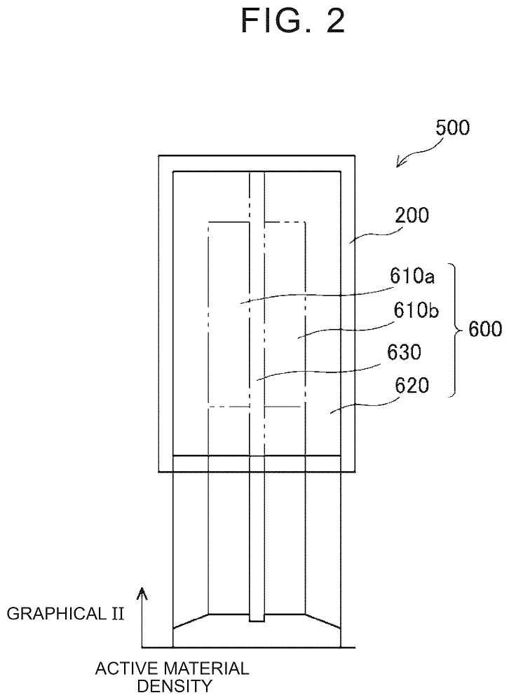

Next, the configuration of the electrode 500 according to the second embodiment will be described with reference to FIG. 2. FIG. 2 is a front view of the electrode 500 according to the second embodiment. The electrode 500 is different from the electrode 100 shown in FIG. 1 in that an active material layer 600 is provided instead of the active material layer 300. The active material layer 300 includes a high-density portion 610, an inclined portion 620, and a communication portion 630. The high-density portion 610 and the inclined portion 620 have the same configuration as the high-density portion 310 and the inclined portion 320 shown in FIG. 1, and thus description thereof will be omitted. As illustrated in FIG. 2, the communication portion 630 is provided so as to communicate from a part of one side of the active material layer 600 to a part of the opposite side. One or a plurality of communication portions 630 may be provided.

The communication portion 630 is any one of a low-density portion, a low-binder portion, and an orientation portion. The low-density portion is a portion where the density of the active material is lower than that of the other regions of the active material layer 600. The graph II is a graph showing the active material density of the active material layers 600 when the communication portion 630 is a low density portion. By providing the low-density portion, the liquid retention property of the active material layer 600 can be further enhanced, and the gas generated in the center of the active material layer 600 can be easily discharged.

The low binder portion is a portion having a lower binder content than the other regions of the active material layer 600. In the low binder portion, the voids between the active materials are larger than in other regions. Therefore, by providing the low binder portion, the same effect as in the case of providing the low-density portion can be obtained.

The orientation portion is a region in which the active material contained in the active material layer 600 is oriented in a predetermined direction. Orientation portion, void cross-sectional area per active material 1 particle is averaged. Therefore, by providing the alignment portion, the same effect as in the case of providing the low-density portion or the low binder portion can be obtained.

Hereinafter, the present disclosure will be described in detail with reference to Examples. The present disclosure is not limited thereto.

### Preparation of Samples

As samples according to Examples and Comparative Examples, samples were prepared by the following method.

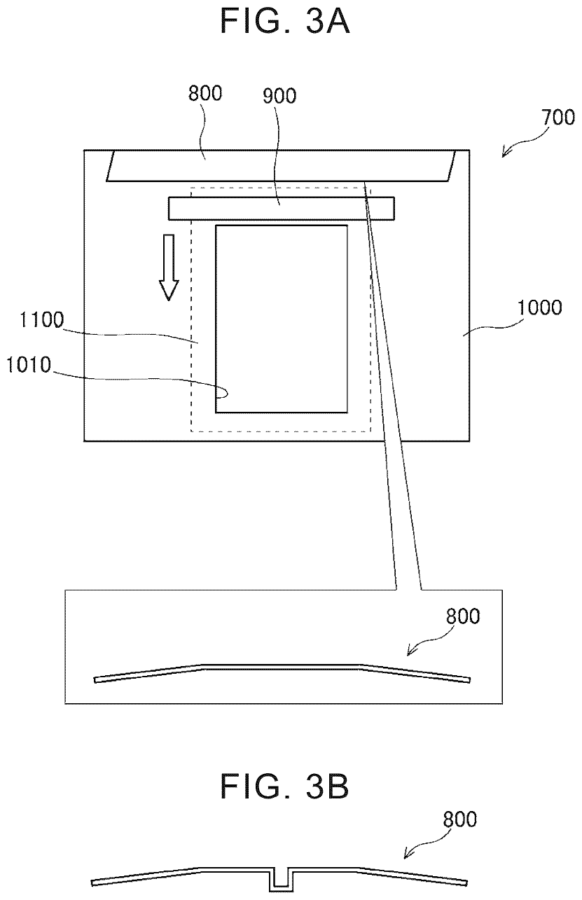

FIG. 3A is a schematic view showing the configuration of the coating apparatus 700 used in preparing the anode sample. The coating apparatus 700 includes a squeegee 800 and a metal frame portion 1000. The coating apparatus 700 is a screen printing apparatus. Specifically, the coating apparatus 700 is an apparatus that applies the anode slurry 900 placed on the metal frame portion 1000 to the copper foil 1100 by the squeegee 800. The arrow shown in FIG. 3A indicates the moving direction of the squeegee 800, that is, the coating direction of the anode slurry. The metal frame portion 1000 is provided with an inner frame 1010. The inner frame 1010 constitutes a wall of the through-hole having a size and shape corresponding to the size and shape of the region to which the slurry is applied. In this embodiment, the size of the inner frame was 30 cm×50 cm. When screen printing was performed, the copper foil 1100 was disposed under the metal frame portion 1000 so that the inner frame 1010 was located in the anode slurry application region, and the anode slurry 900 was applied thereto.

A lower enlarged view of FIG. 3A is a schematic view of a distal end configuration of the squeegee 800. As shown in the enlarged view, using a squeegee 800 both end portions are inclined, the center portion has a high basis weight, the basis weight of both end portions is coated with an anode slurry to obtain a copper foil coated. Next, a copper foil coated with the anode slurry was pressed to prepare an anode. A laminated cell having a 10 Ah capacitance was fabricated using the fabricated anode. The sample thus obtained was used as Example 1.

FIG. 3B is a schematic view of another distal end configuration of a squeegee 800. As shown in FIG. 3B, using a squeegee 800 having both end portions inclined and a recess in the central portion, the central portion has a high basis weight and the basis weight of both end portions has an inclination, and a portion of the central portion is a low basis weight to obtain a copper foil coated anode slurry. Next, a copper foil coated with the anode slurry was pressed to prepare an anode. A laminated cell having a 10 Ah capacitance was fabricated using the fabricated anode. The sample thus obtained was used as Example 2.

Using a squeegee having no inclination at both ends, i.e., a straight tip, a copper foil coated with an anode slurry was obtained so that the basis weight was constant in all regions. Next, a copper foil coated with the anode slurry was pressed to prepare an anode. A laminated cell having a 10 Ah capacitance was fabricated using the fabricated anode. The sample thus obtained was used as Comparative Example 1.

A squeegee having recesses at both end portions was used, and a copper foil coated with an anode slurry was obtained so that both end portions had a low basis weight and the other portions had a high basis weight. Next, a copper foil coated with the anode slurry was pressed to prepare an anode. A laminated cell having a 10 Ah capacitance was fabricated using the fabricated anode. The sample thus obtained was used as Comparative Example 2.

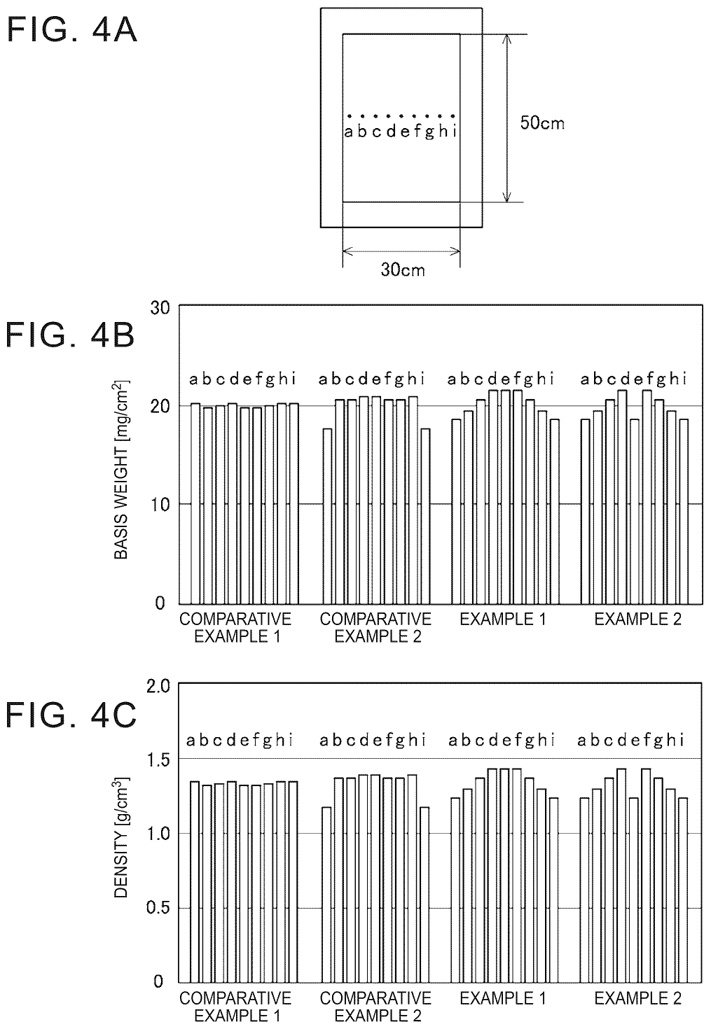

FIG. 4A is a schematic diagram showing an anode of Example 1 to 2 and Comparative Example 1 to 2. FIG. 4B shows a distribution of the weight during slurry coating for the sample of Examples 1 to 2 and Comparative Examples 1 to 2. a to i shown in FIG. 4B correspond to the points a to i illustrated in FIG. 4A. As shown in FIG. 4B, in both Example 1 to 2 and Comparative Example 1 to 2, the squeegee was coated with a basis weight corresponding to the shape of the leading edge. FIG. 4C shows a distribution of the anode density after pressing the sample of Examples 1 to 2 and Comparative Examples 1 to 2. a to i shown in FIG. 4C correspond to the points a to i illustrated in FIG. 4A. As shown in FIG. 4C, in each of Examples 1 to 2 and Comparative Examples 1 to 2, the anode was prepared at an anode density corresponding to the basis weight of the slurry.

After screen printing was performed using a metal frame portion provided with two inner frames which are the same shape and adjacent, a low binder slurry was applied to a groove portion provided in a portion corresponding to a gap between the inner frames. Next, the copper foil coated with the slurry was pressed to produce an anode in which one communicating portion was provided in the active material layer. The coating area of the active material layers included in the prepared anode was the same as that of 1 to 2. In addition, the anode slurry coated on a portion corresponding to a portion other than the communication portion contained SBR (styrene-butadiene rubber) in an 3 wt %. The anode slurry coated on the portion corresponding to the communicating portion contained SBR in 1 wt %. A laminated cell having a 10 Ah capacitance was fabricated using the fabricated anode. The sample thus obtained was used as Example 3.

After the anode slurry was applied to the copper foil using a squeegee having a configuration shown in the lower enlarged view of FIG. 3A, a magnetic field having a magnetic flux-density 0.3 T was applied for 60 seconds to a center part of the anode slurry, that is, a portion corresponding to a communication portion of the active material layers. Next, an anode was prepared by pressing a copper foil coated with a slurry. A laminated cell having a 10 Ah capacitance was fabricated using the fabricated anode. The sample thus obtained was used as Example 4.

### Evaluation of Anode Liquid Retention Rate

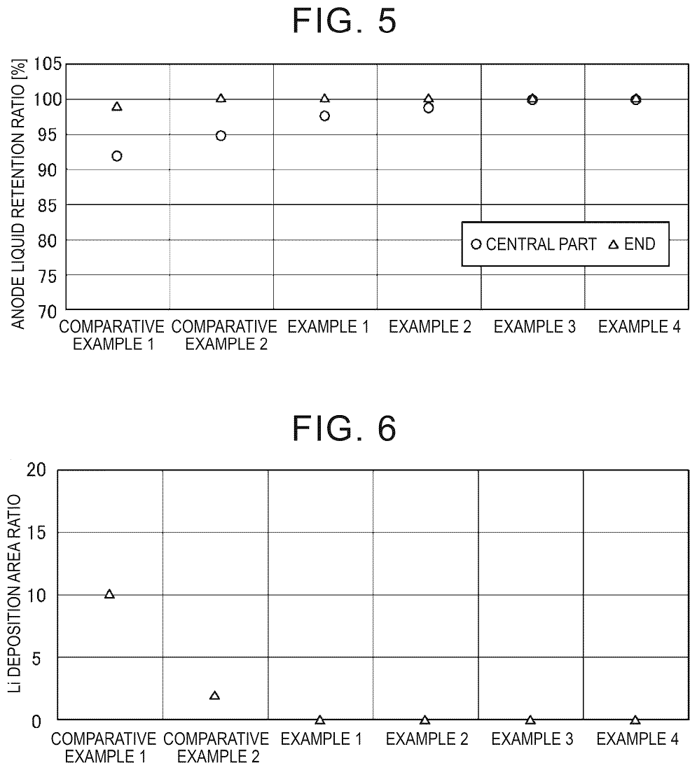

For the samples of Example 1 to 4 and Comparative Example 1 to 2, the cells in the initial-state were disassembled, and the liquid retention ratio of the anode was evaluated. The evaluation results are shown in FIG. 5.

As shown in FIG. 5, at the end portion of the anode, the liquid retention rates of both Example 1 to 4 and Comparative Example 1 to 2 were at a level close to 100%. On the other hand, in the central portion of the anode, the liquid retention ratio of Example 1 to 4 was higher than that of Comparative Example 1 to 2. In particular, in 2 to 4 of the embodiment, the liquid retention ratio in the central portion of the anode was at a level close to 100%. From this, it has been clarified that the liquid retention ratio in the central portion of the active material layer can be improved by providing the inclined portion in the active material layer. Further, it has been clarified that the liquid retention ratio in the central portion of the active material layer can be further improved by providing a communication portion in the active material layer.

### To Evaluate Li Deposition Area

For the samples of Example 1 to 4 and Comparative Example 1 to 2, Li deposition area in the anode was evaluated as an index of the quantity of the generated gases remaining in the electrode-coated area during cycling. Specifically, the samples were charged until SOC100% was reached, and charging and discharging were carried out until SOC10% was reached in a square-wave pattern having a discharge current 1 C. After repeating this process 100 times, the cell was disassembled, and the area of Li deposited on the anode was evaluated. The evaluation results are shown in FIG. 6.

As shown in FIG. 6, in Comparative Example 1, 10% of the anode coated area was Li deposition area. In Comparative Example 2, Li deposition area was reduced as compared with Comparative Example 1, but did not reach a level close to 0%. In 1 to 4 of the embodiment, Li deposition area was approximately 0%. From this, it has been clarified that the discharge of the gas generated in the active material layer can be satisfactorily performed when the active material layer is repeatedly charged and discharged by providing the inclined portion.

The present disclosure is not limited to the above-described embodiments, and can be appropriately modified without departing from the scope of the present disclosure.

What is claimed is:

1. An electrode, comprising:
a current collector; and
an active material layer provided on the current collector, in which
a basis weight of the active material layer is greater than 20 mg/cm², and also a coating area is no less than 600 cm², and
a high-density portion, of which density of active material is high, is provided at a middle of the active material layer, and an inclined portion, in which the density of the active material decrease from the middle toward an edge, is provided at a peripheral edge of the active material layer.

2. The electrode according to claim 1, wherein
the active material layer includes at least one communicating portion communicating from one side of the active material layer to an opposing side, in a part of the active material layer, and
the communicating portion is one of a low-density portion in which the density of the active material is low, a low binder portion in which density of a binder is low, or an orientated portion in which the active material is oriented in a predetermined direction.

3. The electrode according to claim 1, wherein the current collector is an anode current collector, and the active material layer is an anode active material layer.

4. A battery comprising the electrode according to claim 1.
